(19) United States
(12) Patent Application Publication
(10) Pub. No.: US 2016/0300270 A1
(43) Pub. Date: Oct. 13, 2016

(54) Method and Apparatus for Embedding Advertisement into File, System and Terminal

(71) Applicant: HUAWEI TECHNOLOGIES CO., LTD., Shenzhen, Guangdong (CN)

(72) Inventor: Xi CHEN, Nanjing (CN)

(21) Appl. No.: 15/038,247

(22) PCT Filed: Nov. 21, 2013
(86) PCT No.: PCT/CN2013/087594

§ 371 Date: May 20, 2016

(51) Int. Cl. G06Q 30/02

(52) U.S. Cl. CPC G06Q 30/0276; G06Q 30/0277

(57) ABSTRACT

A method for embedding an advertisement into a file where the method includes recording, when a file is processed, an advertisement slot mark for embedding an advertisement, sending the advertisement slot mark to an advertising platform, and storing the advertisement slot mark into the file that is released such that when the released file is presented, a real-time rendering system acquires, from the advertising platform, an advertisement material that matches the advertisement slot mark, and renders the advertisement material to a position that corresponds to the advertisement slot mark in the released file, to generate an advertisement. In the embodiments of the present disclosure, an advertisement slot mark for embedding an advertisement is recorded in a presented file, and an advertisement material that matches the advertisement slot mark is dynamically acquired, thereby implementing dynamic adjustment on a presented advertisement and maximizing advertisement value.

### CROSS-REFERENCE TO RELATED APPLICATION

This application is a U.S. National Stage of International Application No. PCT/CN2013/087594, filed on Nov. 21, 2013, which is hereby incorporated by reference in its entirety.

### TECHNICAL FIELD

The present disclosure relates to video playback technologies, and in particular, to a method and an apparatus for embedding an advertisement into a file, a system and a terminal.

### BACKGROUND

At present, an advertisement may be embedded into a played video (such as a film, a television (TV) play, or a short video). For example, in a embedded advertisement, “Wanglaoji” beverages are put on a dining table in a scenario expressing a victory banquet. The advertisement is deeply embedded into a video, and therefore, during playback of the video, a user does not obviously feel that the video is an advertisement. A propagation effect of the advertisement is improved by means of such imperceptible influence.

In the prior art, an embedded advertisement is mainly done during production of a video. In an example of a film, during film planning, a media department searches, for an embedded advertisement, for a partner (for example, “Wanglaoji”) for sponsorship. During film shooting, an advertised product that needs to be embedded is placed in a scene. During post-production of the film, a video including the advertised product is edited into a video to be formally released. After the video is released, the advertised product may appear in the video during playback of the video (that is, the film) in order to achieve a propagation effect of an embedded advertisement.

However, during research and practice of the prior art, the inventor finds that, once a video is released, an advertised product that is embedded cannot be further adjusted. For example, during video playback, an advertised product presented in a specific scenario is always a “Wanglaoji” beverage, thereby reducing advertisement value in the video.

### SUMMARY

Embodiments of the present disclosure provide a method and an apparatus for embedding an advertisement into a file, a system and an electronic terminal in order to resolve a technical problem, in the prior art, of a reduction of advertisement value in a file resulting from that only a fixed advertised product can be embedded into a file.

To resolve the foregoing technical problem, the embodiments of the present disclosure disclose the following technical solutions.

According to a first aspect, a method for embedding an advertisement into a file is provided, where the method includes recording, when a file is processed, an advertisement slot mark for embedding an advertisement, sending the advertisement slot mark to an advertising platform, and storing the advertisement slot mark into the file that is released such that when presenting the file, a real-time rendering system acquires, from the advertising platform, an advertisement material that matches the advertisement slot mark, and renders the advertisement material to a position that corresponds to the advertisement slot mark in the file.

In a first possible implementation manner of the first aspect, storing the advertisement slot mark into the file includes successively storing the advertisement slot mark into corresponding storage positions in the file according to a time sequence of an advertisement slot in the released file during production of the file, where the time sequence is recorded in the advertisement slot mark.

According to a second aspect, a method for embedding an advertisement into a file is provided, where the method includes receiving an advertisement slot mark for embedding an advertisement into a file, where the advertisement slot mark is sent by an advertisement marking system, receiving a request for acquiring an advertisement material that matches the advertisement slot mark, where the request is sent by a real-time rendering system, performing matching according to an advertisement placement policy to acquire the advertisement material corresponding to the advertisement slot mark, and sending, to the real-time rendering system, the advertisement material acquired by matching such that the real-time rendering system renders the advertisement material to a position that corresponds to the advertisement slot mark in the file.

According to a third aspect, a method for embedding an advertisement into a file is provided, where the method includes, when a released file is presented, identifying an advertisement slot mark in the file, acquiring an advertisement material that matches the advertisement slot mark, and rendering the advertisement material to a position that corresponds to the advertisement slot mark in the file.

With reference to the first aspect, the first possible implementation manner of the first aspect, the second aspect, or the implementation manner of the third aspect, in a second possible implementation manner, the advertisement slot mark includes an advertisement slot identifier (ID) and an advertisement slot ID attribute.

With reference to the first aspect or the first possible implementation manner of the first aspect, or the second aspect, or the second possible implementation manner of the third aspect, in a third possible implementation manner, the advertisement slot ID attribute includes a scenario description text and a target object attribute.

With reference to the first aspect or the first possible implementation manner of the first aspect, or the second aspect, or the second or third possible implementation manner of the third aspect, in a fourth possible implementation manner, the target object attribute includes a category of a target object, a position, a size, and a displaying angle of the target object in each frame of the file.

With reference to the first aspect or the first possible implementation manner of the first aspect, or the second aspect, or the second, third or fourth possible implementation manner of the third aspect, in a fifth possible implementation manner, when the file is a video, the advertisement slot ID attribute further includes a start time and an end time relative to the entire video when the target object appears in the video.

According to a fourth aspect, an apparatus for embedding an advertisement into a file is provided, where the apparatus includes a recording unit configured to mark, when a file is processed, an advertisement slot mark for embedding an advertisement, a sending unit configured to send the advertisement slot mark to an advertising platform, and a storage unit configured to store the advertisement slot mark into the file that is released such that when presenting the file, a real-time rendering system acquires, from the advertising platform, an advertisement material that matches the advertisement slot mark, and renders the advertisement material to a position that corresponds to the advertisement slot mark in the file, to generate an advertisement.

In a first possible implementation manner of the fourth aspect, the storage unit is further configured to successively store the advertisement slot mark into corresponding storage positions in the released file according to a time sequence of an advertisement slot in the released file during production of the file, where the time sequence is recorded in the advertisement slot mark.

According to a fifth aspect, an apparatus for embedding an advertisement into a file is provided, where the apparatus includes a first receiving unit configured to receive an advertisement slot mark for embedding an advertisement into a file, where the advertisement slot mark is sent by an advertisement marking system, a second receiving unit configured to receive a request for acquiring an advertisement material that corresponds to the advertisement slot mark, where the request is sent by a real-time rendering system, a matching unit configured to perform matching according to an advertisement placement policy to acquire the advertisement material corresponding to the advertisement slot mark, and a sending unit configured to send, to the real-time rendering system, the advertisement material acquired by matching such that the real-time rendering system renders the advertisement material to a position that corresponds to the advertisement slot mark in the file, to generate an advertisement.

According to a sixth aspect, an apparatus for embedding an advertisement into a file is provided, where the apparatus includes an identification unit configured to identify an advertisement slot mark in the file when a released file is presented, an acquiring unit configured to acquire an advertisement material that matches the advertisement slot mark, and a generation unit configured to render the advertisement material to a position that corresponds to the advertisement slot mark in the file, to generate an advertisement.

With reference to the fourth aspect or the first possible implementation manner of the fourth aspect, or the fifth aspect or the possible implementation manner of the sixth aspect, in a second possible implementation manner, the advertisement slot mark marked by the recording unit, the advertisement slot mark received by the first receiving unit, and the advertisement slot mark identified by the identification unit each include an advertisement slot ID and an advertisement slot ID attribute.

With reference to the fourth aspect or the first possible implementation manner of the fourth aspect, or the fifth aspect or the second possible implementation manner of the sixth aspect, in a third possible implementation manner, the advertisement slot ID attribute marked by the recording unit, the advertisement slot ID attribute received by the first receiving unit, and the advertisement slot ID attribute identified by the identification unit each include a scenario description text and a target object attribute.

With reference to the fourth aspect or the first possible implementation manner of the fourth aspect, or the fifth aspect, or the second or third possible implementation manner of the sixth aspect, in a fourth possible implementation manner, the target object attribute marked by the recording unit, the target object attribute received by the first receiving unit, and the target object attribute identified by the identification unit each include a category of a target object, and a position, a size, and a displaying angle of the target object in each frame of the file.

With reference to the fourth aspect or the first possible implementation manner of the fourth aspect, or the fifth aspect, or the second, third or fourth possible implementation manner of the sixth aspect, in a fifth possible implementation manner, when the file is a video, the advertisement slot ID attribute marked by the recording unit, the advertisement slot ID attribute received by the first receiving unit, and the advertisement slot ID attribute identified by the identification unit further include a start time and an end time relative to the entire video when the target object appears in the video.

According to a seventh aspect, an electronic terminal is provided, where the electronic terminal includes an advertisement marking system, an advertising platform, and multiple real-time rendering systems, where the advertisement marking system is configured to record, when a file is processed, an advertisement slot mark for embedding an advertisement, send the advertisement slot mark to the advertising platform, and store the advertisement slot mark into the file that is released. The advertising platform is configured to receive the advertisement slot mark for embedding an advertisement, where the advertisement slot mark is sent by the advertisement marking system, receive a request for acquiring an advertisement material that matches the advertisement slot mark, where the request is sent by a real-time rendering system, perform matching according to an advertisement placement policy to acquire the advertisement material corresponding to the advertisement slot mark, and send, to the real-time rendering system, the advertisement material acquired by matching, and each of the real-time rendering systems is configured to, when the released file is presented, identify the advertisement slot mark in the file, send, to the advertising platform, a request for acquiring an advertisement material that matches the advertisement slot mark, receive the advertisement material sent by the advertising platform, and render the advertisement material to a position that corresponds to the advertisement slot mark in the file, to generate an advertisement.

According to an eighth aspect, an electronic terminal is provided, where the electronic terminal includes a processor configured to record, when a file is processed, an advertisement slot mark for embedding an advertisement, and store the advertisement slot mark into the file that is released, a transceiver configured to send the advertisement slot mark marked by the processor to a database. The database configured to store the received advertisement slot mark for embedding an advertisement, where the advertisement slot mark is sent by the transceiver, and a player configured to, when the released file is presented, identify the advertisement slot mark in the released file, and send, to the database, a request for acquiring an advertisement material that matches the advertisement slot mark, where the database is further configured to, when receiving the request sent by the player, perform matching according to an advertisement placement policy to acquire the advertisement material corresponding to the advertisement slot mark, and send, to the player, the advertisement material acquired by matching, and the player is further configured to render the received advertisement material to a position that corresponds to the advertisement slot mark in the file to generate an advertisement, and when the advertisement slot mark in the file is presented, present the advertisement.

From the foregoing technical solutions, it can be known that, in the embodiments of the present disclosure, an advertisement slot mark for embedding an advertisement is recorded when a file is processed, and the advertisement slot mark is sent to an advertising platform and stored into the file that is released such that when presenting the file, a real-time rendering system can dynamically acquire, from the advertising platform, an advertisement material that matches the advertisement slot mark, thereby implementing dynamic adjustment on a presented advertisement, and maximizing advertisement value.

### BRIEF DESCRIPTION OF DRAWINGS

To describe the technical solutions in the embodiments of the present disclosure or in the prior art more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a flowchart of a method for embedding an advertisement into a file according to an embodiment of the present disclosure;

FIG. 2 is another flowchart of a method for embedding an advertisement into a file according to an embodiment of the present disclosure;

FIG. 3 is another flowchart of a method for embedding an advertisement into a file according to an embodiment of the present disclosure;

FIG. 4 is a schematic structural diagram of an apparatus for embedding an advertisement into a file according to an embodiment of the present disclosure;

FIG. 5 is another schematic structural diagram of an apparatus for embedding an advertisement into a file according to an embodiment of the present disclosure;

FIG. 6 is another schematic structural diagram of an apparatus for embedding an advertisement into a file according to an embodiment of the present disclosure;

FIG. 7 is another schematic structural diagram of an apparatus for embedding an advertisement into a file according to an embodiment of the present disclosure;

FIG. 8 is a schematic structural diagram of an electronic terminal according to an embodiment of the present disclosure;

FIG. 9 is a flowchart of an application example according to an embodiment of the present disclosure; and

FIG. 10 is another schematic structural diagram of an electronic terminal according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some rather than all of the embodiments of the present disclosure. All other embodiments obtained by a person of ordinary skill in the art based on the embodiments of the present disclosure without creative efforts shall fall within the protection scope of the present disclosure.

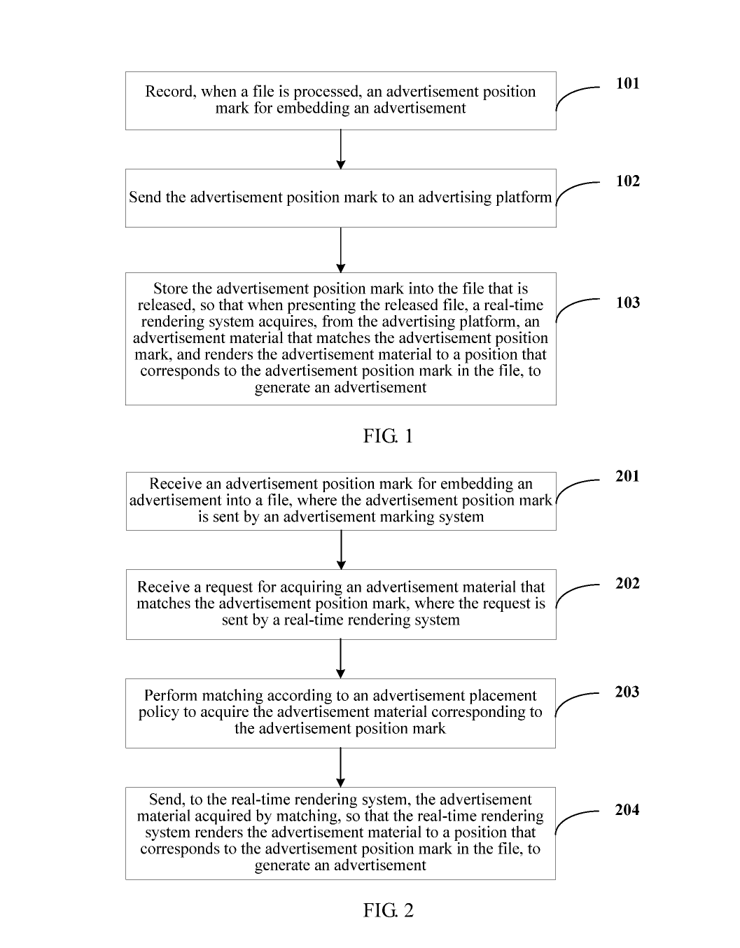

Referring to FIG. 1, FIG. 1 is a flowchart of a method for embedding an advertisement into a file according to an embodiment of the present disclosure. The method includes the following steps.

Step 101: Record, when a file is processed, an advertisement position mark for embedding an advertisement.

In this step, the advertisement slot mark includes, but is not limited to, an advertisement slot ID and an advertisement slot ID attribute, and for different application scenarios, may further adaptively include another parameter, which is not limited in this embodiment.

Optionally, the advertisement slot ID attribute includes a scenario description text and a target object attribute, where the target object attribute may further include a category of a target object, and a position, a size, and a displaying angle of the target object in each frame of the file. Certainly, the advertisement slot ID attribute is not limited thereto, and may further include another parameter, which is not limited in this embodiment.

It should be noted that, the file in this embodiment may be a dynamic video file, or a static file such as a picture or an image. When the file is a static file, the advertisement slot mark needs to include the foregoing parameters. The static file in this specification may also be understood as an image of the video file having only one frame.

Optionally, when the file is a dynamic video file, the advertisement slot ID attribute further includes a start time and an end time relative to the entire video when the target object appears in the video.

For convenience of description, an example in which the file is a video file is used for description below.

A video producer (that is, a file handler in a case of the file) plans to embed an advertisement slot according to a scene situation, and sends an advertisement slot mark for embedding the advertisement slot to an advertisement marking system such that the advertisement marking system records, during shooting of the video (or processing of the file), the advertisement slot mark for embedding the advertisement slot, where the advertisement slot mark includes an advertisement slot ID and an advertisement slot ID attribute. The advertisement slot ID attribute includes a scenario description text, a target object attribute, and a start time and an end time relative to the entire video when the target object appears in the video. For specific parameters included in the target object attribute, reference is made to the foregoing description, and details are not described herein again.

For example, in a scenario of a victory banquet, a beverage of the “Wanglaoji” brand is placed for shooting. Advertisement slot marks that need to be recorded are as follows:

(1) an advertisement slot ID: 00001;

(2) a scenario description text: a victory banquet beverage advertisement slot;

(3) a category of a target object: beverage;

(4) a position, a size, and a displaying angle of the target object in each frame of the video (or file):

position 01: frame number (No.) 345, coordinates (30, 20, 500, 437), size: 10 centimeter (cm), angle: 32 degrees;

position 02: frame No. 346, coordinates (30, 90, 600, 337), size: 14 cm, angle: 32 degrees;

position xx: . . .

(5) a start time and an end time relative to the entire video when the target object appears in the video, that is, duration: 250 millisecond (ms).

It should be noted that, the advertisement slot mark is merely used for fully describing the advertisement slot, to help use, during presentation, the mark to dynamically generate a synthetic video of a target advertisement. Therefore, the advertisement slot mark includes, for example, the foregoing 5 parameters. Certainly, the advertisement slot mark may further adaptively include another parameter according to different systems, which is not limited in this embodiment. The foregoing description is merely a specific application example, but the advertisement slot mark is not limited to the parameter values described in this application example.

Step 102: Send the advertisement position mark to an advertising platform.

In this step, the advertisement marking system sends the recorded advertisement slot mark to the advertising platform such that the advertising platform stores the received advertisement slot mark, and when receiving a request, for acquiring an advertisement material that matches the advertisement slot mark, sent by a real-time rendering system, feeds back the advertisement material that matches the advertisement slot mark to the real-time rendering system according to advertising policy control.

Step 103: Store the advertisement position mark into the file that is released such that when presenting the released file, a real-time rendering system acquires, from the advertising platform, an advertisement material that matches the advertisement position mark, and renders the advertisement material to a position that corresponds to the advertisement position mark in the file, to generate an advertisement.

In this step, a video file is still used as an example of the file. A video producer may perform video production on a shot video using the advertisement marking system. During production of the shot video, the advertisement slot mark is successively stored into corresponding storage positions in the released video file according to a time sequence of an advertisement slot in the released video file, where the time sequence is recorded in the advertisement slot mark. In this embodiment, the storage position is also referred to as an additional video description block. Certainly, in this step, the advertisement slot mark may also be successively stored into corresponding storage positions in the released video file according to an arrangement sequence of the advertisement slot in a frame of the released video file, where the arrangement sequence is recorded in the advertisement slot mark. For example, if the video is in a format of National Television System Committee (NTSC), and a second is divided into 24 frames, that is, from frame 0 to frame 23, the advertisement slot mark may be successively stored into corresponding storage positions in the released video file according to a sequence of frame 0 to frame 23.

In this embodiment of the present disclosure, an advertisement slot mark for placing an advertisement is recorded in a file processing process, and the advertisement slot mark is sent to an advertising platform and stored into a released file. Therefore, when presenting the file, a real-time rendering system can dynamically acquire, from the advertising platform, an advertisement material that matches the advertisement slot mark, thereby implementing dynamic adjustment on a presented advertisement, and maximizing advertisement value.

Further, referring to FIG. 2, FIG. 2 is another flowchart of a method for embedding an advertisement into a file according to an embodiment of the present disclosure. The method includes the following steps.

Step 201: Receive an advertisement position mark for embedding an advertisement into a file, where the advertisement position mark is sent by an advertisement marking system.

The advertisement slot mark includes an advertisement slot ID and an advertisement slot ID attribute.

Optionally, the advertisement slot ID attribute includes a scenario description text and a target object attribute. The target object attribute includes a category of a target object, and a position, a size, and a displaying angle of the target object in each frame of the file.

Optionally, when the file is a video, the advertisement slot ID attribute further includes a start time and an end time relative to the entire video when the target object appears in the video.

In this step, after receiving an advertisement slot mark of an embedded advertisement, an advertising platform first stores the advertisement slot mark, and then establishes, according to an advertisement placement policy, a correspondence between the advertisement slot mark and an advertisement material corresponding to the advertisement slot mark.

One advertisement slot mark may correspond to one advertisement material, or correspond to multiple advertisement materials according to different advertisement placement policies, which is not limited in this embodiment.

Step 202: Receive a request for acquiring an advertisement material that matches the advertisement position mark, where the request is sent by a real-time rendering system.

Step 203: Perform matching according to an advertisement placement policy to acquire the advertisement material corresponding to the advertisement position mark.

In this step, when receiving a request for acquiring an advertisement material, the advertising platform performs matching according to the advertisement placement policy, to acquire the advertisement material corresponding to the advertisement slot mark.

It should be noted that, according to different advertisement placement policies, for a same advertisement slot mark, advertisement materials acquired by matching may be different or same, which is not limited in this embodiment.

Step 204: Send, to the real-time rendering system, the advertisement material acquired by matching such that the real-time rendering system renders the advertisement material to a position that corresponds to the advertisement position mark in the file, to generate an advertisement.

In this step, the advertising platform sends, to the real-time rendering system, the advertisement material acquired by matching such that the real-time rendering system renders, when receiving the advertisement material acquired by matching, the advertisement material to the position that corresponds to the advertisement slot mark in the file, to generate the advertisement.

In this embodiment of the present disclosure, the advertising platform first stores a received advertisement slot mark for embedding an advertisement into a file, when receiving a request for acquiring an advertisement material that matches the advertisement slot mark, performs matching according to an advertisement placement policy to acquire the corresponding advertisement material, and feeds back the advertisement material, thereby implementing dynamic adjustment on the advertisement material.

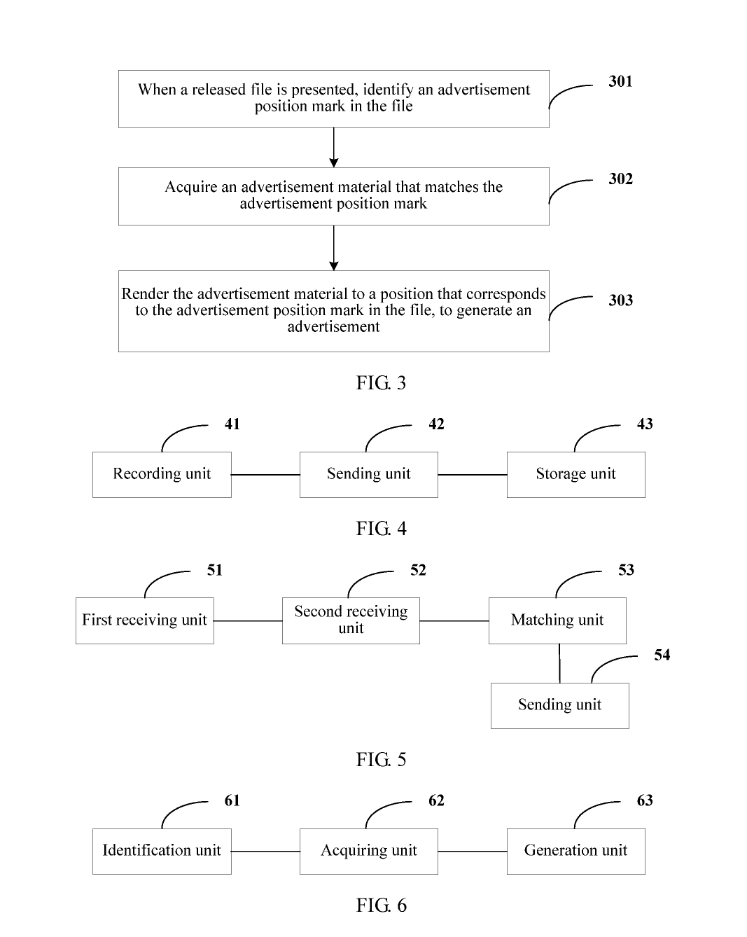

Further, referring to FIG. 3, FIG. 3 is another flowchart of a method for embedding an advertisement into a file according to an embodiment of the present disclosure. The method includes the following steps.

Step 301: When a released file is presented, identify an advertisement position mark in the file.

The advertisement slot mark includes an advertisement slot ID and an advertisement slot ID attribute.

Optionally, the advertisement slot ID attribute includes a scenario description text and a target object attribute, where the target object attribute includes a category of a target object, a position, a size, and a displaying angle of the target object in each frame of the file.

Optionally, when the file is a video, the advertisement slot ID attribute further includes a start time and an end time relative to the entire video when the target object appears in the video.

In this step, a manner in which a real-time rendering system identifies an advertisement slot mark by determining whether there is an advertisement slot mark at a corresponding storage position (such as in an additional description block) in the presented file.

Step 302: Acquire an advertisement material that matches the advertisement position mark.

If the file is presented, and the real-time rendering system identifies that there is an advertisement slot mark in the file, the real-time rendering system sends, to an advertising platform, a request for acquiring an advertisement material that matches the advertisement slot mark, and receives the advertisement material that matches the advertisement slot mark and that is sent by the advertising platform according to an advertisement placement policy.

Step 303: Render the advertisement material to a position that corresponds to the advertisement position mark in the file, to generate an advertisement.

In this step, the real-time rendering system dynamically synthesizes, according to the advertisement slot mark and the advertisement material returned by the advertising platform, a frame sequence in which the advertisement material is embedded in order to generate the advertisement.

Optionally, in another embodiment that is based on the foregoing embodiment, the method may further include presenting the generated advertisement when the advertisement slot mark in the file is presented.

In this embodiment of the present disclosure, when a file is presented, if there is an advertisement slot mark in the file, an advertisement material that matches the advertisement slot mark may be dynamically acquired in order to implement dynamic management on an advertisement slot in the file. That is, subtly present an advertisement in a scenario of the file, which not only achieves a very good propagation effect but also maximizes advertisement value in the file.

Based on the implementation processes of the foregoing methods, an embodiment of the present disclosure further provides an apparatus for embedding an advertisement into a file, and a schematic structural diagram of the apparatus is shown in FIG. 4. The apparatus includes a recording unit 41, a sending unit 42, and a storage unit 43.

The recording unit 41 is configured to mark, when a file is processed, an advertisement slot mark for embedding an advertisement.

Optionally, the advertisement slot mark marked by the recording unit 41 includes an advertisement slot ID and an advertisement slot ID attribute, where the advertisement slot ID attribute includes a scenario description text and a target object attribute. The target object attribute includes a category of a target object, a position, a size, and a displaying angle of the target object in each frame of the file.

Optionally, when the file is a video, the advertisement slot mark marked by the recording unit 41 further includes a start time and an end time relative to the entire video when the target object appears in the video.

The sending unit 42 is configured to send the advertisement slot mark to an advertising platform.

The storage unit 43 is configured to store the advertisement slot mark into the file that is released such that when presenting the file, a real-time rendering system acquires, from the advertising platform, an advertisement material that matches the advertisement slot mark, and renders the advertisement material to a position that corresponds to the advertisement slot mark in the file, to generate an advertisement.

The storage unit 43 is further configured to successively store the advertisement slot mark into corresponding storage positions in the file according to a time sequence of an advertisement slot in the released file during production of the file, where the time sequence is recorded in the advertisement slot mark.

For details about implementation processes of functions and roles of the units in the apparatus, reference is made to the implementation processes of corresponding steps in the foregoing methods, and details are not described herein again.

Further, referring to FIG. 5, FIG. 5 is another schematic structural diagram of an apparatus for embedding an advertisement into a file according to an embodiment of the present disclosure. The apparatus includes a first receiving unit 51, a second receiving unit 52, a matching unit 53, and a sending unit 54.

The first receiving unit 51 is configured to receive an advertisement slot mark for embedding an advertisement into a file, where the advertisement slot mark is sent by an advertisement marking system.

The advertisement slot mark received by the first receiving unit 51 includes an advertisement slot ID and an advertisement slot ID attribute. The advertisement slot ID attribute includes a scenario description text and a target object attribute, where the target object attribute includes a category of a target object, a position, a size, and a displaying angle of the target object in each frame of the file.

Optionally, when the file is a video, the advertisement slot mark received by the first receiving unit 51 further includes a start time and an end time relative to the entire video when the target object appears in the video.

The second receiving unit 52 is configured to receive a request for acquiring an advertisement material that corresponds to the advertisement slot mark, where the request is sent by a real-time rendering system.

The matching unit 53 is configured to perform matching according to an advertisement placement policy to acquire the advertisement material corresponding to the advertisement slot mark.

The sending unit 54 is configured to send, to the real-time rendering system, the advertisement material acquired by matching such that the real-time rendering system renders the advertisement material to a position that corresponds to the advertisement slot mark in the file, to generate an advertisement.

For details about implementation processes of functions and roles of the units in the apparatus, reference is made to the implementation processes of corresponding steps in the foregoing methods, and details are not described herein again.

Further, referring to FIG. 6, FIG. 6 is another schematic structural diagram of an apparatus for embedding an advertisement into a file according to an embodiment of the present disclosure. The apparatus includes an identification unit 61, an acquiring unit 62, and a generation unit 63.

The identification unit 61 is configured to identify an advertisement slot mark in a file when the released file is presented.

The advertisement slot mark identified by the identification unit 61 includes an advertisement slot ID and an advertisement slot ID attribute. The advertisement slot ID attribute includes a scenario description text and a target object attribute, where the target object attribute includes a category of a target object, a position, a size, and a displaying angle of the target object in each frame of the file.

Optionally, when the file is a video, the advertisement slot mark identified by the identification unit 61 further includes a start time and an end time relative to the entire video when the target object appears in the video.

The acquiring unit 62 is configured to acquire an advertisement material that matches the advertisement slot mark.

The generation unit 63 is configured to render the advertisement material to a position that corresponds to the advertisement slot mark in the file, to generate an advertisement.

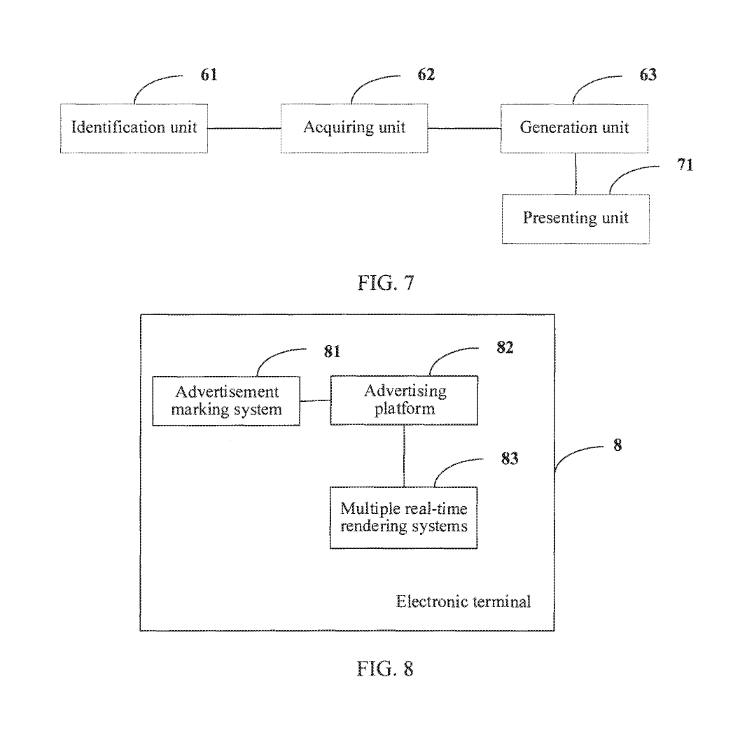

Optionally, in another embodiment that is based on the foregoing embodiment, the apparatus may further include a presenting unit 71, and a schematic structural diagram of the apparatus is shown in FIG. 7. FIG. 7 is another schematic structural diagram of an apparatus for embedding an advertisement into a file according to an embodiment of the present disclosure.

The presenting unit 71 is configured to present the advertisement that is generated by the generation unit 63 when the advertisement slot mark in the file is presented.

For details about implementation processes of functions and roles of the units in the apparatus, reference is made to the implementation processes of corresponding steps in the foregoing methods, and details are not described herein again.

Accordingly, an embodiment of the present disclosure further provides an electronic terminal, and a schematic structural diagram of the electronic terminal is shown in FIG. 8. The electronic terminal 8 includes an advertisement marking system 81, an advertising platform 82, and multiple real-time rendering systems 83.

The advertisement marking system 81 is configured to record, when a file is processed, an advertisement slot mark for embedding an advertisement, send the advertisement slot mark to the advertising platform, and store the advertisement slot mark into the file that is released.

The advertising platform 82 is configured to receive the advertisement slot mark for embedding an advertisement, where the advertisement slot mark is sent by the advertisement marking system 81, receive a request for acquiring an advertisement material that matches the advertisement slot mark, where the request is sent by a real-time rendering system 83, perform matching according to an advertisement placement policy to acquire the advertisement material corresponding to the advertisement slot mark, and send, to the real-time rendering system 83, the advertisement material acquired by matching.

Each of the real-time rendering systems 83 is configured to, when the released file is presented, identify the advertisement slot mark in the file, send, to the advertising platform 82, a request for acquiring an advertisement material that matches the advertisement slot mark, receive the advertisement material sent by the advertising platform 82, and render the advertisement material to a position that corresponds to the advertisement slot mark in the file, to generate an advertisement.

Optionally, the electronic terminal 8 may further include at least one presenting system, where the presenting system is configured to present the file, and present the advertisement generated by the real-time rendering system when the advertisement slot mark in the file is presented.

Optionally, the real-time rendering system is integrated with the presenting system.

Optionally, in another embodiment, the advertisement marking system 81, the advertising platform 82, and the multiple real-time rendering systems 83 may be integrated on two electronic terminals, or integrated on three or more different electronic terminals, which is not limited in this embodiment. For example, the advertisement marking system 81 is integrated on an electronic terminal A, the advertising platform 82 is integrated on an electronic terminal B, one real-time rendering system 83 is integrated on an electronic terminal C, and another real-time rendering system 83 is integrated on an electronic terminal D, and so forth.

That is, in this embodiment, the multiple real-time rendering systems may be integrated on one electronic terminal or different electronic terminals.

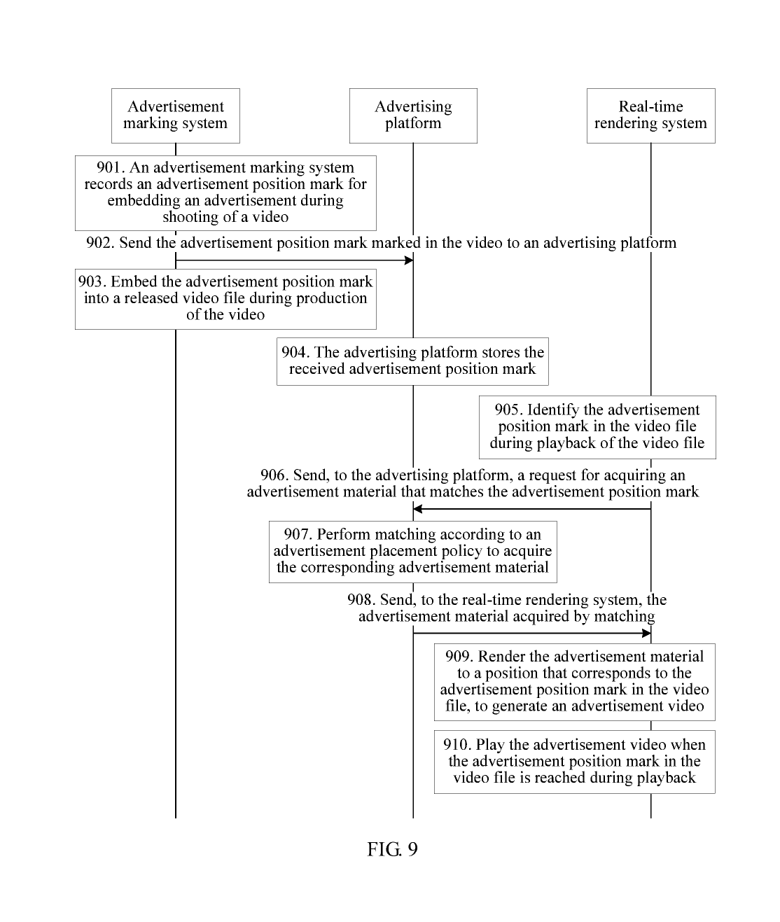

Further, referring to FIG. 9, FIG. 9 is a flowchart of an application example according to an embodiment of the present disclosure. Using a video as an example of a file in this embodiment, the application example further includes the following steps.

Step 901: An advertisement marking system records an advertisement position mark for embedding an advertisement during shooting of a video.

In this step, the advertisement marking system records, according to an embedded advertisement slot planned by a video producer, the advertisement slot mark during shooting of the video, where the advertisement slot mark includes an advertisement slot ID and an advertisement slot ID attribute. For example, in a scenario of a victory banquet, a beverage of the “Wanglaoji” brand is placed for shooting. The advertisement marking system marks the following advertisement slot ID attribute. The advertisement slot ID attribute is further shown as above, and details are not described herein again.

Step 902: The advertisement marking system sends the advertisement position mark marked in the video to an advertising platform, and the advertising platform performs registration.

Step 903: The advertisement marking system embeds the advertisement position mark into a released video file during production of the video.

Step 904: The advertising platform stores the received advertisement position mark.

During specific implementation, there is no time sequence between step 903 and step 904, which may also be performed at the same time.

Step 905: A real-time rendering system identifies the advertisement position mark in the video file during playback of the video file.

Step 906: The real-time rendering system sends, to the advertising platform, a request for acquiring an advertisement material that matches the advertisement position mark.

Step 907: After receiving the advertisement position mark, the advertising platform performs matching according to an advertisement placement policy to acquire the corresponding advertisement material.

For example, an advertisement material acquired this time by performing matching according to the advertisement placement policy is a material of the “JIADUOBAO” brand.

Step 908: The advertising platform sends, to the real-time rendering system, the advertisement material acquired by matching.

The advertising platform returns an advertisement resource according to the advertisement slot mark and the advertisement placement policy. For example, according to the advertisement placement policy, the material of the “JIADUOBAO” brand is returned after the current matching.

Step 909: The real-time rendering system renders, when receiving the advertisement material, the advertisement material to a position that corresponds to the advertisement position mark in the video file, to generate an advertisement video.

In this step, the real-time rendering system renders the advertisement resource in real time according to information about the advertisement slot mark in order to update the video file.

Step 910: The real-time rendering system plays the advertisement video when the advertisement position mark in the video file is reached during playback. That is, what the audience sees is an embedded advertisement video of a “JIADUOBAO” product.

In this embodiment of the present disclosure, an advertisement slot mark for embedding an advertisement is marked in a video in order to dynamically update an embedded advertisement in a video (such as a film, a TV play, or a short video). Which brand of an embedded advertisement appears in a scenario during video playback on earth is controlled by an advertising platform placement policy, and an advertisement slot in the video is dynamically managed by an advertising platform and a real-time rendering system, that is, an advertisement video may be subtly presented in a scenario of the video, which not only achieves a very good propagation effect but also maximizes advertisement value in the video.

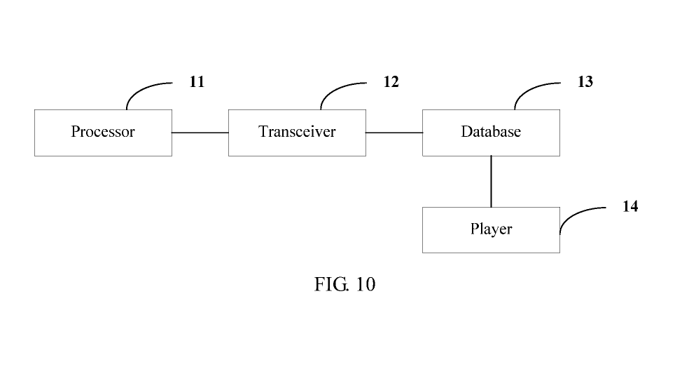

Accordingly, an embodiment of the present disclosure further provides an electronic terminal, and a schematic structural diagram of the electronic terminal is shown in FIG. 10. The electronic terminal includes a processor 11, a transceiver 12, a database 13, and a player 14 (in this embodiment, one player is used as an example, but this embodiment is not limited thereto, and there may also be multiple players connected to the database separately).

The processor 11 is configured to record, when a file is processed, an advertisement slot mark for embedding an advertisement, and store the advertisement slot mark into the file that is released.

The transceiver 12 is configured to send the advertisement slot mark marked by the processor 11 to the database.

The database 13 is configured to store the received advertisement slot mark for embedding an advertisement, where the advertisement slot mark is sent by the transceiver 12.

The player 14 is configured to, when the released file is presented, identify the advertisement slot mark in the file, and send, to the database 13, a request for acquiring an advertisement material that matches the advertisement slot mark.

The database 13 is further configured to, when receiving the request sent by the player 14, perform matching according to an advertisement placement policy to acquire the advertisement material corresponding to the advertisement slot mark, and send, to the player 14, the advertisement material acquired by matching.

The player 14 is further configured to render the received advertisement material to a position that corresponds to the advertisement slot mark in the file to generate an advertisement, and when the advertisement slot mark in the file is presented, present the advertisement.

It should be noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion such that a process, a method, an article, or a device that includes a list of elements not only includes those elements but also includes other elements that are not expressly listed, or further includes elements inherent to such a process, method, article, or device. An element preceded by “includes a . . . ” does not, without more constraints, preclude the presence of additional identical elements in the process, method, article, or device that includes the element.

Based on the foregoing descriptions of the embodiments, a person skilled in the art may clearly understand that the present disclosure may be implemented by software in addition to a necessary universal hardware platform or by hardware only. In most circumstances, the former is a preferred implementation manner. Based on such an understanding, the technical solutions of the present disclosure essentially or the part contributing to the prior art may be implemented in a form of a software product. The software product is stored in a storage medium, such as a read-only memory (ROM)/random-access memory (RAM), a hard disk, or an optical disc, and includes several instructions for instructing a computer device (which may be a personal computer, a server, a network device, or the like) to perform the methods described in the embodiments or some parts of the embodiments of the present disclosure.

The foregoing descriptions are merely exemplary implementation manners of the present disclosure. It should be noted that a person of ordinary skill in the art may make several improvements or polishing without departing from the principle of the present disclosure and the improvements or polishing shall fall within the protection scope of the present disclosure.

1. A method for embedding an advertisement into a file, comprising:
recording, when the file is processed, an advertisement slot mark for embedding the advertisement;
sending the advertisement slot mark to an advertising platform; and
storing the advertisement slot mark into the file that is released that such that when presenting the file, a real-time rendering system acquires, from the advertising platform, an advertisement material that matches the advertisement slot mark, and renders the advertisement material to a position that corresponds to the advertisement slot mark in the file.

2. The method according to claim 1, wherein storing the advertisement slot mark into the file comprises successively storing the advertisement slot mark into corresponding storage positions in the file according to a time sequence of an advertisement slot in the released file during production of the file, wherein the time sequence is recorded in the advertisement slot mark.

3. (canceled)

4. A method for embedding an advertisement into a file, comprising:
identifying an advertisement slot mark in the file when a released file is presented;
acquiring an advertisement material that matches the advertisement slot mark; and
rendering the advertisement material to a position that corresponds to the advertisement slot mark in the file.

5. The method according to claim 4, wherein the advertisement slot mark comprises an advertisement slot identifier (ID) and an advertisement slot ID attribute.

6. The method according to claim 5, wherein the advertisement slot ID attribute comprises a scenario description text and a target object attribute.

7. The method according to claim 6, wherein the target object attribute comprises a category of a target object, a position, a size, and a displaying angle of the target object in each frame of the file.

8. The method according to claim 5, wherein when the file is a video, the advertisement slot ID attribute further comprises a start time and an end time relative to the entire video when a target object appears in the video.

9. An apparatus for embedding an advertisement into a file, comprising:
a transmitter;
a memory; and
a computer processor,
wherein the transmitter, the memory, and the computer processor are coupled to each other,
wherein the computer processor is configured to mark, when the file is processed, an advertisement slot mark for embedding the advertisement,
wherein the transmitter is configured to send the advertisement slot mark to an advertising platform, and
wherein the memory is configured to store the advertisement slot mark into the file that is released such that when presenting the file, a real-time rendering system acquires, from the advertising platform, an advertisement material that matches the advertisement slot mark, and renders the advertisement material to a position that corresponds to the advertisement slot mark in the file, to generate an advertisement.

10. The apparatus according to claim 9, Wherein the memory is further configured to successively store the advertisement slot mark into corresponding storage positions in a released file according to a time sequence of an advertisement slot in the released file during production of the file, wherein the time sequence is recorded in the advertisement slot mark.

11. (canceled)

12. An apparatus for embedding an advertisement into a file, comprising:
a memory; and
a computer processor coupled to the memory and configured to:
identify an advertisement slot mark in the file when a released file is presented;
acquire an advertisement material that matches the advertisement slot mark; and
render the advertisement material to a position that corresponds to the advertisement slot mark in the file, to generate the advertisement.

13. The apparatus according to claim 12, wherein the identified advertisement slot mark comprises an advertisement slot identifier (ID) and an advertisement slot ID attribute.

14. The apparatus according to claim 13, wherein the advertisement slot ID attribute comprises a scenario description text and a target object attribute.

15. The apparatus according to claim 14, wherein the target object attribute comprises a category of a target object, a position, a size, and a displaying angle of the target object in each frame of the file.

16. The apparatus according to claim 15, wherein when the file is a video, the advertisement slot ID attribute further comprises a start time and an end time relative to the entire video when the target object appears in the video.

17.-18. (canceled)
